(19) United States
(12) Patent Application Publication
(10) Pub. No.: US 2004/0204796 A1
(43) Pub. Date: Oct. 14, 2004

(54) Method and apparatus for validating vehicle operators and management of validation information

(76) Inventors: John Harvey, San Diego, CA (US); David T. Chesavage, San Diego, CA (US); Michael L. Segal, Carlsbad, CA (US); Thomas F. Doyle, San Diego, CA (US)

Correspondence Address: Qualcomm Incorporated, Patents Department, 5775 Morehouse Drive, San Diego, CA, 92121-1714, US

(21) Appl. No.: 10/217,394

(22) Filed: Aug. 12, 2002

(51) Int. Cl. G06F 17/00

(52) U.S. Cl. 701/1; 340/426.11

(57) ABSTRACT

A method and apparatus for validating a vehicle operator. In one embodiment, an apparatus comprises an input device for allowing entry of vehicle operator identification information, a transceiver for transmitting a validation request and for receiving a response to the request, a memory for storing pre-determined identification information, an interface for allowing a processor to communication with a vehicle sub-system, and a processor connected to the input device, the transceiver, the memory, and the interface, the processor for receiving the vehicle operator identification information from the input device, for generating the validation request if at least a portion of the vehicle operator identification information is not found in the memory, and for controlling operation of the vehicle via the interface, in accordance with instructions contained in the response.

### BACKGROUND

I. Field of the Invention

The present invention relates to the field of vehicle security. More specifically, the present invention relates to a method and apparatus for providing vehicle security using a vehicle-based or host-based system to control vehicle access and functionality.

II. Description of the Related Art

Anti-theft and/or theft-deterrent devices for motor vehicles are known, in the prior art, for preventing or thwarting the theft of motor vehicles. These known devices may be of the active or passive variety and are typically available in many forms (i.e. steering wheel locks, hood locks, ignition system cut-off devices, alarms, etc.). In some cases, these devices may be of a very simple design, while in other cases, they may be of a more sophisticated design. However, as is well known, these known anti-theft and/or theft-deterrent devices and systems may be easily defeated by car thieves, and especially, by professional car thieves. Experience has shown that even the most sophisticated of anti-theft and/or theft-deterrent devices may be defeated by an experienced, and determined, vehicle thief.

Some prior art theft-deterrent systems prevent movement of a vehicle using an electronic control system. The electronic control system typically will not allow the vehicle to start unless a pre-assigned passcode is entered into the electronic control system by a vehicle operator. The passcode entered by the vehicle operator is compared to a passcode that is stored in a memory as part of the electronic control system. If the two passcodes match, the vehicle is enabled and normal operation of the vehicle ensues. However, if the two passcodes do not match, the vehicle is prevented from starting.

One problem with the aforementioned theft-deterrent system is that it is difficult to manage. Often, it is necessary to physically access the electronic control system to change the passcode stored within. This may be due to a number of reasons, but mainly if the password becomes known by one or more unauthorized parties. This may occur intentionally, in the case of a disgruntled driver, or unintentionally, by sloppy safekeeping practices. In other cases, over a long period of time, it may be assumed that the password has been compromised in some fashion.

Another problem with the electronic control system described above is that the consequence of entering an incorrect password is limited to a single event that is defined, usually, by the manufacturer of the electronic control system. In many cases, it would be desirable to allow a third party, such as a vehicle owner, to define what happens if an incorrect password is entered into the electronic control device.

What is needed is a theft-deterrent system that is easy to manage while also allowing vehicle owners more control over the consequences of an incorrect passcode access attempt.

### SUMMARY

A method and apparatus for validating vehicle operators. In one embodiment, an apparatus comprises an input device for allowing entry of vehicle operator identification information, a memory for storing pre-defined identification information, a processor for comparing the pre-defined identification information to the vehicle operator identification information and for generating a validation request if a portion of the vehicle operator identification information is not contained within the memory, and a transceiver for transmitting the validation request to a remote location and for receiving a response to the validation request.

Alternatively, an apparatus for validating a vehicle operator comprises a signal-bearing medium tangibly embodying a program of machine-readable instructions for performing a method of validating a vehicle operator, executable by a digital processing apparatus, the method comprising operations of receiving vehicle operator identification information, comparing the vehicle operator identification information to pre-defined identification information stored in a memory, controlling operation of a vehicle if at least a portion of the vehicle operator identification information is found in the memory, and transmitting a validation request to a remote location if at least a portion of the vehicle operator identification information is not found in the memory.

In another embodiment, an apparatus for managing validation information comprises an input device for allowing entry of vehicle operator identification information and a memory for storing the vehicle operator identification information if at least a portion of the vehicle operator identification information is not already stored in the memory. A processor determines whether or not the portion of the vehicle operator identification information is stored in the memory, generates a validation request message and assigns a time value to the vehicle operator identification information if the portion of the vehicle operator identification information is not stored in the memory. Subsequently, the processor removes the vehicle operator identification information from the memory after expiration of the time value. The apparatus additionally comprises a transceiver for transmitting the validation request message to a remote location and for receiving a response to the validation request message.

Alternatively, an apparatus for managing validation information comprises a signal-bearing medium tangibly embodying a program of machine-readable instructions executable by a digital processing apparatus to perform a method for managing validation information, the method comprising operations of receiving vehicle operator identification information, determining whether or not a portion of the vehicle operator identification information is already stored in a memory, storing the vehicle operator identification information in the memory if at least a portion of the vehicle operator identification information is not already stored in the memory, generating a validation request message if at least a portion of the vehicle operator identification information is not already stored in the memory, transmitting the validation request message, assigning a time value to the vehicle operator identification information if at least a portion of the vehicle operator identification information is not already stored in the memory, and removing the vehicle operator identification information from the memory after upon expiration of the time value.

### BRIEF DESCRIPTION OF THE DRAWINGS

The features, advantages, and objects of the present invention will become more apparent from the detailed description as set forth below, when taken in conjunction with the drawings in which like referenced characters identify correspondingly throughout, and wherein:

FIG. 1 illustrates a satellite-based wireless communication system in which the method and apparatus for validating vehicle operators is used;

FIG. 2 is a functional block diagram of one embodiment of a mobile communication terminal used in the communication system of FIG. 1;

FIG. 3 is a flow diagram illustrating a method for validating vehicle operators; and

FIG. 4 is a flow diagram illustrating a method for managing vehicle operator identification information.

### DETAILED DESCRIPTION

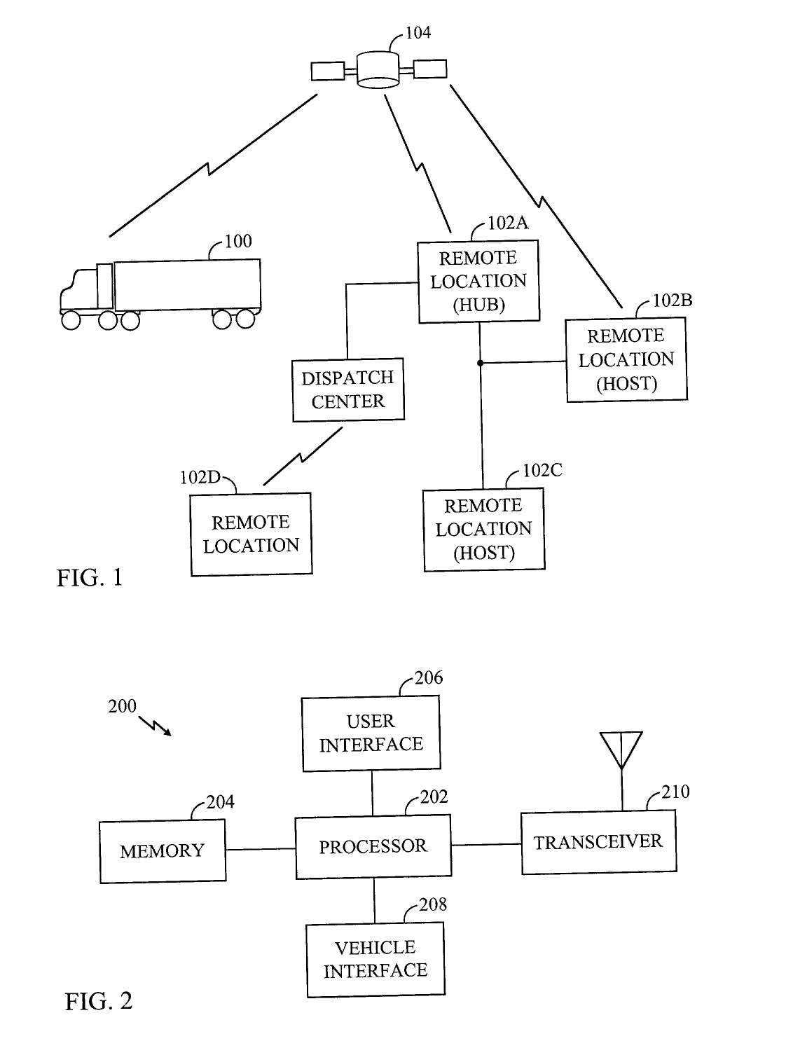

FIG. 1 illustrates a based-based wireless communication system widely used in the trucking industry for allowing two-way communications between vehicle operators and third parties, such as a fleet management center, family members, governmental authorities, and so on. Although the method and apparatus for validating vehicle operators is described herein with respect to system a satellite-based communication system, it should be understood that any other wireless communication system could be used in the alternative, including cellular and PCS terrestrial communications, microwave communications, and so on. It should also be understood that the method and apparatus for validating vehicle operators could also be used to validate operators of a number of different types of vehicles, such as buses, aircraft, automobiles, watercraft, or any other machine in which operator validation is desired.

As used throughout this specification, the term “validation” or “validate” means to determine whether or not a vehicle operator is authorized to operate a vehicle. Also, as used throughout, the term “vehicle operator” means any person who attempts to become validated, whether that person is a vehicle operator, a vehicle passenger, a vehicle maintenance worker, and so on.

Referring now to FIG. 1, vehicle 100, in this example, comprises a tractor-trailer, commonly used in the long-haul trucking industry. Vehicle 100 comprises a mobile communication terminal (MCT, not shown) for communicating with a remote location 102a via satellite 104. Generally, the MCT resides onboard a tractor portion of vehicle 100, in one embodiment. In one embodiment, remote location 102a comprises a central processing center, otherwise known as a “hub” or “network management center (NMC) and serves as a central communication point between MCT-equipped vehicles and their respective dispatch centers, other designated office(s), shippers, consignees, governmental authorities, family members, and so on. For example, in FIG. 1, remote location 102a passes communications between remote host or remote location 102b and vehicle 100. Remote location 102b comprises a vehicle dispatch center which generally monitors and controls a fleet of vehicles 100.

Communications between remote location 102b and vehicle 100 may further be passed to one or more other remote locations, such as remote location (host) 102c. Remote location 102c comprises any number of interested third parties to communications between remote location 102b and vehicle 100. For example, remote location 102c could be a another designated office of remote location 102b, a shipper of goods being carried by vehicle 100, a consignee of goods being carried by vehicle 100, a governmental unit, a personal computer, and so on. Communications among remote locations 102a, 102b, and 102c may be carried out by any known communication techniques, including telephone, internet, dedicated lines, wireless links, and so on.

In addition to remote locations 102a, 102b, and 102c, remote location 102d is shown which comprises a mobile entity, such as an emergency vehicle (police car, fire truck, etc), an individual, an aircraft, etc. Generally, communications between a remote location 102a and remote location 102d are routed through a dispatch center 106 associated with remote location 102d. Communications between dispatch center 106 and remote location 102d may employ any well-known wireless communication method, such as cellular, satellite, RF, Land Mobile Radio (LMR), or others. Communications between dispatch center 106 and remote location 102a (or other remote locations 102) generally occur using landline communications, such as a telephone link, a fiber optic connection, the Internet, or others. Located onboard remote location 102d is a two-way wireless communication device which is able to send and receive information to and from one or more of the remote locations 102 or an MCT. Remote location 102d might, for example, receive information identifying a certain vehicle 100 that is not operating with a validated vehicle operator operating the vehicle. Remote location may then transmit one or more commands to vehicle 100/MCT, either directly to vehicle 100/MCT, or through dispatch center 106, to disable or impair the operation of vehicle 100.

In another embodiment, communications to and/or from vehicle 100 are transmitted directly to/from remote location 102b and/or 102c without being processed by a central communication center, such as remote location 102a.

The MCT located on vehicle 100 transmits and receives communications wirelessly using, in one embodiment, a satellite 104. In other embodiments, the MCT uses a terrestrial wireless communication system to communicate with remote location 102a, such as an analog or a digital cellular telephone system, an RF communication system, or a wireless data communication network, such as a cellular digital packet data (CDPD) network.

FIG. 2 is a functional block diagram of one embodiment of the MCT, discussed above, herein MCT 200. MCT 200 generally comprises a processor 202, a memory 204, a user interface 206, and a vehicle interface 208. It should be understood that the functional blocks shown in FIG. 2 may be housed together in a single MCT unit, or they may be distributed in any combination throughout vehicle 100. For example, the transceiver 210 may or may not be incorporated into the physical structure of MCT 200.

Processor 202 generally comprises circuitry necessary for executing machine-readable instructions stored in memory 204. For example, processor 202 may comprise a microprocessor and supporting circuitry, such as the Intel 80x86 or Pentium series of microprocessors. Of course, other electronic processors could be used in the alternative.

Memory 204 may comprise one or more signal-bearing mediums tangibly embodying one or more programs of machine-readable instructions executable by a digital processing apparatus, such as processor 202. Typically, memory 204 comprises one or more volatile and/or non-volatile memories, such as a read-only memory (ROM), random-access memory (RAM), electrically erasable programmable read-only memory (EEPROM), a hard drive, a floppy disk drive and floppy disk, or a flash memory. Memory 204 is used to store instructions relating to the operation of MCT 200 including instructions relating to communications with remote location(s) 102. For example, instructions may be stored relating to the detection of certain vehicle operating characteristics, such as the vehicle location, vehicle speed, engine RPM, load status, driver status, etc. Other information stored within memory 204 generally includes instructions for processor 202 to communicate with remote location(s) 102. Further, instructions may be stored for managing and controlling vehicle 100. For instance, if a validation is unsuccessful, instructions may be stored within memory 204 for impairing operation of vehicle 100. Each vehicle may have a distinct set of instructions stored within memory 204 for controlling vehicle 100 during pre-defined events.

User interface 206 allows a vehicle operator of MCT 200 to enter instructions into MCT 200, typically comprising a keyboard or keypad and a visual display device. Of course, user interface 206 could alternatively comprise other types of interfaces, such as a microphone for entering audible commands, a pointing device such as a mouse, light pen, trackball, and/or a speaker for generating audible information to a vehicle operator. Other types of well-known devices could be used, either alternatively or in combination, with the devices just mentioned. For example, user interface may, alternatively or in addition, comprise a bio-metric device or a card reader.

A vehicle operator of MCT 200, typically an operator of vehicle 100, enters vehicle operator identification information into MCT 200 using user interface 206, either prior to operating vehicle 100 or subsequently after initial use. The vehicle operator identification information typically comprises a passcode, such as a predefined vehicle operator name and password, although other types of information may be used to validate the vehicle operator, such as a social security number or, in general, a vehicle operator-defined numeric or alpha-numeric code used in combination (or not) with a password.

Alternatively, or in conjunction with one or more I/O devices just described, user interface 206 comprises a biometric device, such as a fingerprint reader, retinal scanner, or voice recognition device. A vehicle operator of MCT 200 then identifies himself/herself to MCT 200 by providing the necessary biological identification information to user interface 206. In this case, the vehicle operator identification information comprises the biometric information.

Vehicle interface 208 allows processor 202 to communicate with one or more electronic control units (ECUs) located onboard vehicle 100, either directly, or through one or more intermediary devices, such as an onboard computer (not shown). Vehicle interface 208 comprises a communication port such as a serial data port for communicating, for example, with an onboard computer. Alternatively, vehicle interface 208 comprises a port for interfacing to a vehicle data bus, such as a J1708 data bus commonly used in vehicles today. Examples of ECUs include a fuel regulator/cutoff switch, an ignition controller, an electronic transmission controller, a steering wheel locking mechanism, and a brake activation unit. Other examples of ECUs include electronic devices which provide operational information about vehicle 100 to processor 202. For example, these types of ECUs comprise a speed sensor, an RPM sensor, an odometer, or a location sensor such as a GPS receiver.

In modern vehicles, the ECUs may be interconnected by a data bus, such as a data bus as specified in SAE J1708, a commonly known communication standard. The data bus is connected to vehicle interface 208 so that communications may take place between processor 202 and the various ECUs connected to the data bus.

Transceiver 210 comprises circuitry to modulate information from processor 202 and convert the modulated information into high frequency signals suitable for wireless transmission. Similarly, transceiver 210 also comprises circuitry to convert received high frequency communication signals into signals suitable for demodulation and subsequent processing by processor 202.

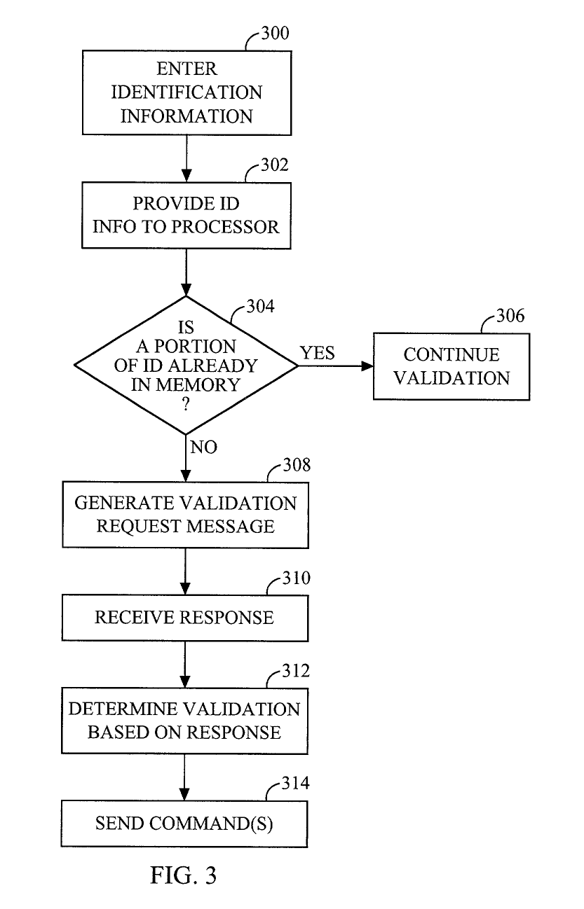

FIG. 3 is a flow diagram illustrating a method for validating vehicle operators. The method may be embodied as a set of machine-readable instructions executable by a digital processing apparatus and stored in memory 204. In step 300, a vehicle operator identifies himself/herself to apparatus 200 by entering vehicle operator identification information into apparatus 200 using user interface 206. As explained above, the vehicle operator identification information may comprise a vehicle operator name and password, biometric information, or other information.

The vehicle operator identification information is provided to processor 202, as shown in step 302. In step 304, processor 202 determines if at least a portion of the vehicle operator identification information is stored in memory 204. For example, if the vehicle operator identification information comprises a username and a password, processor 202 checks memory 204 to determine if at least the username is stored therein. If the username is found in memory 204, this indicates that the vehicle operator has been validated previously to apparatus 200, and processing continues to step 306. If the username is not found in memory 204, this indicates that the vehicle operator has not been previously authorized to operate vehicle 100, or that a previous authorization has occurred more than a predetermined amount of time in the past, and processing continues to step 308.

In step 306, processor 202 continues to validate the vehicle operator by comparing the remaining vehicle operator identification information to the remaining pre-determined identification information stored in memory 204.

In step 308, processor 202 generates a validation request message to remote location 102, the validation request message comprising the vehicle operator identification information and, generally, a request for remote location 102 to validate the vehicle operator. Remote location 102 authorizes the vehicle operator by comparing the vehicle operator identification information to pre-determined information stored in a memory at remote location 102, or by forwarding the vehicle operator identification information to a third party for validation. Once validation has been performed, a response to the validation request message is transmitted back to vehicle 100 and received by transceiver 210, as shown in step 310.

The response comprises information indicating whether or not the vehicle operator was successfully validated or not. This may be done explicitly, or it may be done implicitly if the response comprises instructions for controlling the operation of vehicle 100. If the response comprises instructions for impairing operation of vehicle 100, then processor 102 determines, in step 312, that validation was not successful. If the response comprises instructions for allowing vehicle 100 to operate normally, then processor 102 determines, again in step 312, that validation was successful.

In step 314, processor 102 sends one or more commands through vehicle interface 208 to one or more ECUs or other vehicle control systems to control operation of vehicle 100. If validation was not successful, processor 102 sends one ore more instructions via vehicle interface 208 to impair or restrict operation of vehicle 100. For example, a fuel cut-off switch might be activated, a vehicle braking system activated, or an ignition system might be disabled. Alternatively, or in addition to the actions described above, processor 102 could take other actions not necessarily tied to preventing vehicle movement. Such other actions might include activating a vehicle horn, headlights, taillights, or interior lights, locking or unlocking one or more doors, and so on. If validation was successful, processor 102 sends one or more instructions via vehicle interface 208 which allows vehicle 100 to operator normally. For example, a fuel cut-off switch may be disabled, a vehicle braking system deactivated, or an ignition system activated. Of course, other vehicle systems could be enabled by processor 202, either alternatively or in addition, to the examples just listed.

The instructions for controlling operation of vehicle 100 are either stored in memory 204, or they are supplied by the response to a validation request message, depending on the implementation.

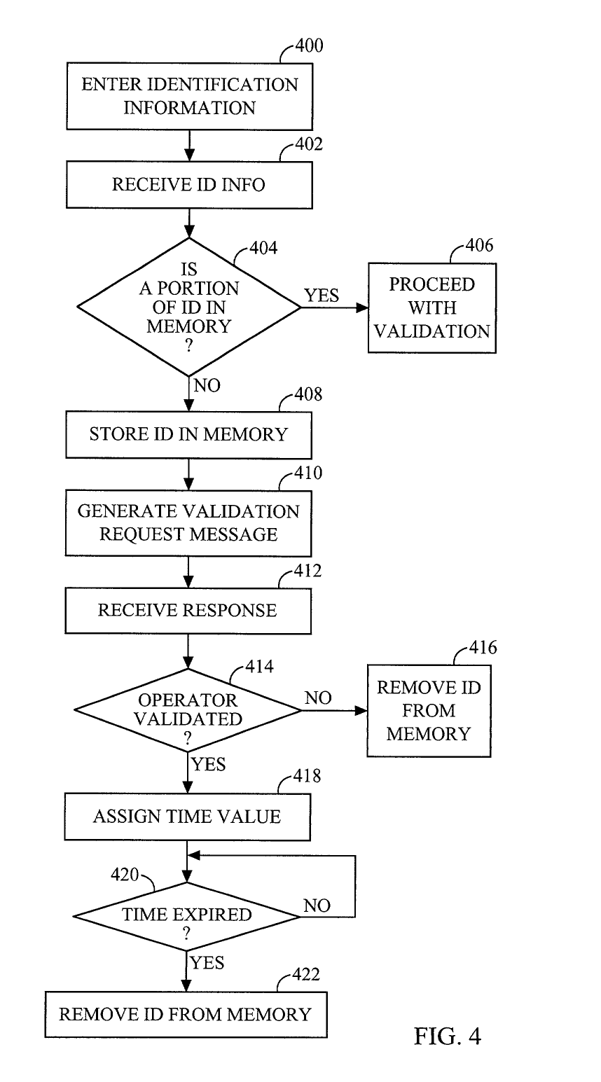

FIG. 4 is a flow diagram illustrating a method for managing validation information, for example, vehicle operator identification information. The method may be embodied as a set of machine-readable instructions executable by a digital processing apparatus and stored in memory 204.

In step 400, a vehicle operator provides vehicle operator identification information to processor 202 via user interface 206. Processor 202 receives the vehicle operator identification information in step 402, then tries to match at least a portion of the vehicle operator identification information to any pre-determined identification information stored in memory 204, as shown in step 404. If a match is not found, processing continues to step 408. If a match is found, validation proceeds as described above with respect to FIG. 3, as shown as step 406.

In step 408, the vehicle operator identification information provided by the vehicle operator in step 400 is stored in memory 204 for subsequent validations, subject to the following steps. In step 410, a validation request message is generated by processor 202 and transmitted to remote location 102 for validation, as discussed previously with respect to FIG. 3. Subsequently, a response to the validation request message is received in step 412. The response comprises information indicating whether or not the vehicle operator was successfully validated or not.

In step 414, processor 202 determines from the response whether or not the vehicle operator was validated by remote location 102. If the vehicle operator was not successfully validated, processing continues to step 416, where the vehicle operator identification information stored in memory 204 is removed by processor 202. The vehicle operator may then be asked to attempt validation again. If the vehicle operator was successfully validated, the vehicle operator identification information previously stored in memory 204 is left stored in memory 204. In step 418, a time value is assigned to the vehicle operator identification information, such as the time that the response was received, or a time indicating when the vehicle operator provided the vehicle operator identification information back in step 400.

At a time subsequent to step 418, processor 202 determines whether the time value has expired, i.e., whether an amount of time equal to the time value has passed or whether the present time equals the time value, as shown in step 420. In one embodiment, processor 202 performs step 420 at regularly scheduled time intervals. In another embodiment, processor 202 performs step 420 any time a vehicle operator attempts validation. In yet another embodiment, the time assigned to the vehicle operator identification information is implemented as a countdown timer. Other ways of determining expiration of the time value are, of course, possible.

When the assigned amount of time expires, processor 202 removes the corresponding vehicle operator identification information from memory 204, as shown in step 422. The time value is chosen so that vehicle operators who are frequently operating vehicle 100 do not have to validated by remote location 102 upon every validation attempt, thereby saving the cost of transmitting the validation request message and subsequent response. If a vehicle operator corresponding to the stored vehicle operator identification information attempts validation before expiration of the time value, step 404 is performed, and the time value is reset.

The previous description of the preferred embodiments is provided to enable any person skilled in the art to make and use the present invention. The various modifications to these embodiments will be readily apparent to those skilled in the art, and the generic principles defined herein may be applied to other embodiments without the use of the inventive faculty. Thus, the present invention is not intended to be limited to the embodiments discussed herein, but is to be accorded the widest scope consistent with the principles and novel features disclosed herein.

I claim:

1-23. Cancelled

24. An apparatus for managing validation information, comprising:
an input device for allowing entry of vehicle operator identification information;
a memory for storing said vehicle operator identification information if at least a portion of said vehicle operator identification information is not already stored in said memory;
a processor for determining whether or not said portion of said vehicle operator identification information is stored in said memory, for generating a validation request message and for assigning a time value to said vehicle operator identification information if said portion of said vehicle operator identification information is not stored in said memory, and for removing said vehicle operator identification information from said memory after expiration of said time value; and
a transceiver for transmitting said validation request message to a remote location and for receiving a response to said validation request message.

25. A signal-bearing medium tangibly embodying a program of machine-readable instructions executable by a digital processing apparatus to perform a method for managing validation information, said method comprising operations of:
receiving vehicle operator identification information;
determining whether or not a portion of said vehicle operator identification information is already stored in a memory;
storing said vehicle operator identification information in said memory if at least a portion of said vehicle operator identification information is not already stored in said memory;
generating a validation request message if at least a portion of said vehicle operator identification information is not already stored in said memory;
transmitting said validation request message;
assigning a time value to said vehicle operator identification information if at least a portion of said vehicle operator identification information is not already stored in said memory; and
removing said vehicle operator identification information from said memory after upon expiration of said time value.
